(19) United States
(12) Patent Application Publication
(10) Pub. No.: US 2008/0078886 A1
(43) Pub. Date: Apr. 3, 2008

(54) LAUNCH VEHICLE CARGO CARRIER

(75) Inventors: Mark A. Foster, Huntington Beach, CA (US); Russell B. Livermore, Alto, NM (US)

Correspondence Address: CANADY & LORTZ LLP - BOEING, 2540 HUNTINGTON DRIVE, SUITE 205, SAN MARINO, CA, 91108, US

(73) Assignee: The Boeing Company, Chicago, IL (US)

(21) Appl. No.: 11/466,353

(22) Filed: Aug. 22, 2006

(51) Int. Cl. B64G 1/00

(52) U.S. Cl. 244/173.1

(57) ABSTRACT

A cargo carrier is disclosed for the efficient delivery of cargo to space, such as to support the International Space Station (ISS). Both pressurized and unpressurized cargo may be delivered into space on an expendable launch vehicle, such as the Delta-IV rocket. The cargo carrier may utilize a slightly modified Delta-IV second stage to provide on-orbit station keeping of the payload until it is transferred to the ISS. The cargo carrier can include an unpressurized section having a rigid central structure supporting a frame to which unpressurized cargo modules are coupled. In addition, a pressurized cargo section may be coupled to the unpressurized section. The cargo carrier may utilize existing on-orbit assets such as the European Automated Transfer Vehicle (ATV) to transfer the ISS cargo from a rendezvous orbit to the ISS.

### BACKGROUND OF THE INVENTION

1. Field of the Invention

This invention relates to launch vehicles for space applications. Particularly, this invention relates to the structure and configuration of launch vehicle cargo carriers for space applications.

2. Description of the Related Art

As a consequence of the Presidential mandate to retire the Space Shuttle fleet on or before 2010, NASA is struggling with how to meet crew logistical (e.g.; food and consumables) and station maintenance requirements (e.g.; replacement of failed components).

Retiring the Shuttle by 2010 is problematic since there is currently not a launch vehicle system comparable to the U.S. Space Shuttle that is capable of efficiently delivering the large upmass and volume requirements of ISS Outfitting and Resupply cargo. There is generally a need for cost effective methods and systems for delivering payloads to space. Further, there is presently a specific need for such methods and systems to deliver cargo to the International Space Station (ISS) once the Space Shuttle is permanently retired in 2010.

Although all ISS Assembly Outfitting & Resupply cargo has been specifically designed to be compatible with launch on the United States Space Shuttle, as a space cargo vehicle, the Space Shuttle is relatively expensive to launch and maintain, particularly when compared to the costs of unmanned vehicles. Furthermore, it is expected that the Space Shuttle will be phased out of operation by 2010. However, the ISS is expected to be operational thru 2016 and probably longer and will require methods and systems for cargo delivery that can support its operation.

The only other existing manned system which currently provides similar space cargo delivery capability are the Russian Progress vehicles. However, the Russian Progress vehicles have a limited upmass capability and deliver only pressurized cargo.

Other methods and systems in development which may augment current space cargo delivery capabilities are the European Automated Transfer Vehicle (ATV), scheduled to be launched in 2007, and the Japanese H-II Transfer Vehicle (HTV), scheduled to be launched in 2009. The ATV has a limited upmass capability and delivers only pressurized cargo. Thus, the ATV is not compatible with all ISS Assembly Outfitting and Resupply cargo. In addition, the ATV is costly to launch. Although the HTV can provide limited pressurized and unpressurized cargo to ISS, like the ATV, the HTV is costly to launch and is also not compatible all ISS Assembly Outfitting and Resupply cargo.

Designed as an unmanned launch vehicle, the Delta-IV rocket is not adequate for the ISS cargo task in its standard form. The Delta-IV second stage is not compatible with ISS Visiting Vehicle (ISS-VV) requirements. In addition, it would be very complicated and costly to modify and qualify the Delta-IV second stage to be compatible with the ISS-VV requirements. Furthermore, the Delta-IV launch system is not designed to be compatible with on-orbit Extra-Vehicular Activity (EVA) or ISS Extra-Vehicular Robotic (EVR) requirements. Other space cargo devices have also been developed.

U.S. Pat. No. 5,605,308 by Quan et al., issued Feb. 25, 1997, discloses a dispenser for ejecting space vehicles from a launch vehicle. The dispenser includes an inverted outer truncated cone and an upright inner truncated cone positioned within the outer cone and connected thereto at lower end portions thereof. The cones are mounted on the launch vehicle. The dispenser also includes a mounting platform secured to the outer cone and inner cone at upper end portions thereof. Hinges detachably pivotally mount the space vehicles on the mounting platform, and separation nuts and bolts releasably secure the vehicles to the platform. Spring actuators mounted in the platform provide pivoting of all or any individual vehicle relative to the mounting platform resulting in separation and ejection of the vehicles from the launch vehicle. However, this dispenser is designed to deliver satellites, not cargo, and is not compatible with either the ISS or the Outfitting and Resupply cargo.

In view of the foregoing, there is a need in the art for systems and methods for providing efficient space cargo delivery. In addition, there is a need for such systems and methods to provide space cargo delivery of both pressurized and unpressurized cargo, e.g. outfitting & resupply cargo to the ISS. These and other needs are met by the present invention as detailed hereafter.

### SUMMARY OF THE INVENTION

A cargo carrier is disclosed for the efficient delivery of cargo to space, such as to support the International Space Station (ISS). Both pressurized and unpressurized cargo may be delivered into space on an expendable launch vehicle, such as the Delta-IV rocket. The cargo carrier may utilize a slightly modified Delta-IV second stage to provide on-orbit station keeping of the payload until it is transferred to the ISS. Since the Delta-IV second stage is already a nominal part of every launch, embodiments of the invention can maximize the useable cargo upmass and the utility of required launch components, while minimizing additional costs. The cargo carrier can include an unpressurized section having a rigid central structure supporting a frame to which unpressurized cargo modules are coupled. In addition, a pressurized cargo section may be coupled to the unpressurized section. The cargo carrier may utilize existing on-orbit assets such as the European Automated Transfer Vehicle (ATV) to transfer the ISS cargo from a rendezvous orbit to the ISS.

The cargo carrier can be modified to perform several missions. For example, the cargo carrier pressurized section can be loaded with pressurized cargo and launched on a Delta-IV medium plus or larger launch vehicle to deliver pressurized cargo to the ISS. In addition, the cargo carrier unpressurized carrier section can be loaded with unpressurized cargo and launched on a Delta-IV medium plus or larger launch vehicle to deliver unpressurized cargo to the ISS. When fully configured, the cargo carrier can be loaded with both pressurized and unpressurized cargo and launched on a Delta-IV heavy or larger launch vehicle to deliver both pressurized and unpressurized cargo to the ISS.

A typical embodiment of the invention comprises a cargo carrier including a rigid central structure having a first docking port, a frame attached to the rigid central structure, and one or more coupling devices, each for coupling an unpressurized cargo module to the frame. The cargo carrier may comprise a payload for an expendable launch vehicle such as a Delta-IV rocket and the first docking port may be compatible with an Automated Transfer Vehicle (ATV) which can operate as an in-space tug vehicle to transfer the cargo carrier to the ISS.

In further embodiments, the cargo carrier further comprises a pressurized cargo section attached to the rigid central structure and having a second docking port. The second docking port may be compatible with an International Space Station Common Berthing Mechanism. In addition, the pressurized cargo section may comprise one or more structural interfaces, each for an International Standard Payload Rack (ISPR).

The rigid central structure of the cargo carrier may comprise a hollow composite cylinder. In addition, Flight Releasable Attach Mechanisms (FRAM) may be used as the one or more coupling devices and each of the unpressurized cargo modules may be International Space Station Orbital Replacement Units (ORUs). The cargo carrier frame may include four trusses, each extending radially from the rigid central structure, and an upper shelf and a lower shelf, coupled to each of the four trusses and the rigid central structure. The cargo carrier frame may be designed to support a plurality of unpressurized cargo modules coupled to the four trusses and the upper shelf.

Similarly, a typical method embodiment of the invention for delivering cargo to space comprises the steps of launching a cargo carrier with a launch vehicle to a rendezvous orbit, maintaining station keeping at the rendezvous orbit with at least one stage of the launch vehicle, docking a first docking port of the cargo carrier with a tug vehicle, disengaging the launch vehicle from the cargo carrier, and maneuvering the cargo carrier to a specific destination in orbit with the tug vehicle. The cargo carrier comprises a rigid central structure including the first docking port, a frame attached to the rigid central structure, and one or more coupling devices, each for coupling an unpressurized cargo module to the frame.

### BRIEF DESCRIPTION OF THE DRAWINGS

Referring now to the drawings in which like reference numbers represent corresponding parts throughout:

FIGS. 1A and 1B illustrate an exemplary launch vehicle cargo carrier embodiment of the invention;

FIG. 2 illustrates top, side and isometric detailed views of the unpressurized section of the exemplary launch vehicle cargo carrier embodiment of the invention;

FIG. 3 illustrates the unpressurized section of the exemplary launch vehicle cargo carrier embodiment of the invention including attached cargo modules;

FIG. 4 illustrates an exemplary concept of operations for a launch vehicle cargo carrier embodiment of the invention; and

FIG. 5 is a flowchart of an exemplary method for delivering cargo to space implementing an embodiment of the invention.

### DETAILED DESCRIPTION OF THE PREFERRED EMBODIMENT

1. Overview

A cargo carrier embodiment of the present invention can be used to deliver all of the yearly ISS resupply cargo requirements in a single launch. The cargo carrier can be designed to be compatible with all ISS assembly outfitting and resupply cargo. Throughout the specification, the invention may be described as being launched on a Delta-IV rocket (a specific model of expendable launch vehicle), however, embodiments of the present invention are not limited to this particular launch vehicle; any suitable launch vehicle may be implemented with the invention.

A cargo carrier embodiment of the invention can utilize existing on-orbit assets to transfer ISS cargo from an insertion orbit to the ISS, resulting in much greater usable cargo upmass than any competing solution. By utilizing existing on-orbit assets to transfer the cargo from insertion orbit to the ISS, there is no need to qualify new hardware to meet ISS visiting vehicle requirements, resulting in a significant cost and schedule savings. One exemplary embodiment of the cargo carrier (referred to as a Delta-IV Cargo Carrier (D-CC)) may be designed and optimized specifically to launch ISS cargo on a Delta-IV Heavy or Medium plus launch vehicle resulting in a highly integrated and efficient space cargo delivery solution. The D-CC solution can provide an estimated total yearly system cost savings of seventy-five percent or more compared to any other solution currently operational or planned for operation prior to 2014.

The D-CC embodiment of the invention can provide ISS Assembly Elements and Outfitting & Resupply cargo with basic on-orbit attitude control, communication to ground controllers, thermal control, etc. until it can be transferred to or installed on the ISS. An on-orbit transfer mechanism (such as the European ATV) may be used to move the launched ISS outfitting and resupply cargo from insertion orbit to rendezvous and berth or dock with ISS.

The D-CC may be launched on a Delta-IV heavy or a medium plus launch vehicle into a LEO insertion orbit at 51.6 degrees inclination and approximately 200 nautical mile (nm) altitude. The Delta-IV second stage can provide on-orbit station keeping (e.g. primarily communications and attitude control) for the cargo carrier while it waits for rendezvous with the ATV from the ISS. Once the ATV successfully rendezvous and captures the D-CC, a clamp band releases the second stage and PAF which then drop away, revealing the pressurized berthing port (CBM). The ATV may then maneuver the D-CC within reach of the ISS Remote Manipulator System (i.e. a robotic arm) that captures the cargo carrier and berths it to a docking port (e.g. node 2) of the ISS. The D-CC may then be unloaded by the crew resident on-board the ISS.

The Flight Releasable Attach Mechanisms (FRAM) which may be employed in embodiments of the invention as a coupling device to each of the unpressurized cargo modules, is designed to provide a single, generic mounting platform for International Space Station (ISS) cargo/payload elements. Using adaptive Flight Support Equipment (FSE) structures, the FRAM allows cargo/payload elements to interface with the United States On-orbit Segment (USOS), ISS Ground System, National Space Transportation System (NSTS) Orbiter, and ISS for transportation, on-orbit handling, stowage and/or preparation for operation. The FRAM System comprises Passive and Active FRAM components. Prior to launch, the Passive FRAM may be attached to the D-CC and various external payload and stowage structures to be used on the ISS. Similar pre-launch activities involve attachment of the Active FRAM to various ISS cargo. Then, the Passive FRAM/Active FRAM mating provides for attachment of ISS cargo to the D-CC for launch and on-orbit events, as well as to the ISS for on-orbit events. A full description of the FRAM, its uses and configurations is provided in NASA document number D684-10822-01, dated 10 SEP. 2002, Revision A, STANDARD INTERFACE DEFINITION DOCUMENT for the THE FLIGHT RELEASABLE ATTACHMENT MECHANISM (FRAM) SYSTEM, which is incorporated by reference herein.

The International Space Station Orbital Replacement Units (ORUs) which may be used as each of the unpressurized cargo modules attached to a FRAM and carried by a cargo carrier embodiment of the invention is defined by the NASA ISS program as an item that can be removed from a system and replaced as a unit at the organizational on-orbit level of maintenance. Examples of ORUs include batteries, electronic modules, pumps, heat exchangers, nitrogen and oxygen tank assemblies, heat exchangers, and several other components and assemblies.

A pressurized cargo section used in a cargo carrier embodiment of the invention may comprise one or more structural interfaces, each for an International Standard Payload Rack (ISPR). The ISPRs are structural frames that support efficient integration and interchangeability of payload hardware. The ISPR on ISS provide a common set of interfaces regardless of location. Each NASA ISPR provides approximately 1.6 m3 (55.5 ft3) of internal volume. The rack weighs approximately 104 kg (230 lbm) and can accommodate up to an additional 700 kg (1543 lbm) of payload equipment. The rack has internal mounting provisions to allow attachment of secondary structure. The ISPRs are outfitted with a thin center post to accommodate sub-rack-sized payloads, such as the approximately 48.3 cm (19 in) Spacelab Standard Interface Rack (SIR) Drawer or the Space Shuttle Middeck Locker. Utility pass-through ports are located on each side to allow cables to be run between Racks. Module attachment points are provided at the top of the rack and via pivot points at the bottom. The pivot points support installation and maintenance. Tracks on the exterior front posts allow mounting of payload equipment and laptop computers. Additional adapters on the ISPRs are provided for ground handling. Services available through ISPR interfaces include Power, Thermal Management, Command and Data Handling, Video, Vacuum Exhaust System (Waste Gas), Vacuum Resource, Nitrogen, Carbon Dioxide, Argon, and Helium. More information on the ISPR can be found in the generic NASA accommodations online document, at http://stationpayloads.jsc.nasa.gov/E-basicaccomodations/E3.html#ispr, which is incorporated by reference herein.

2. Launch Vehicle Cargo Carrier

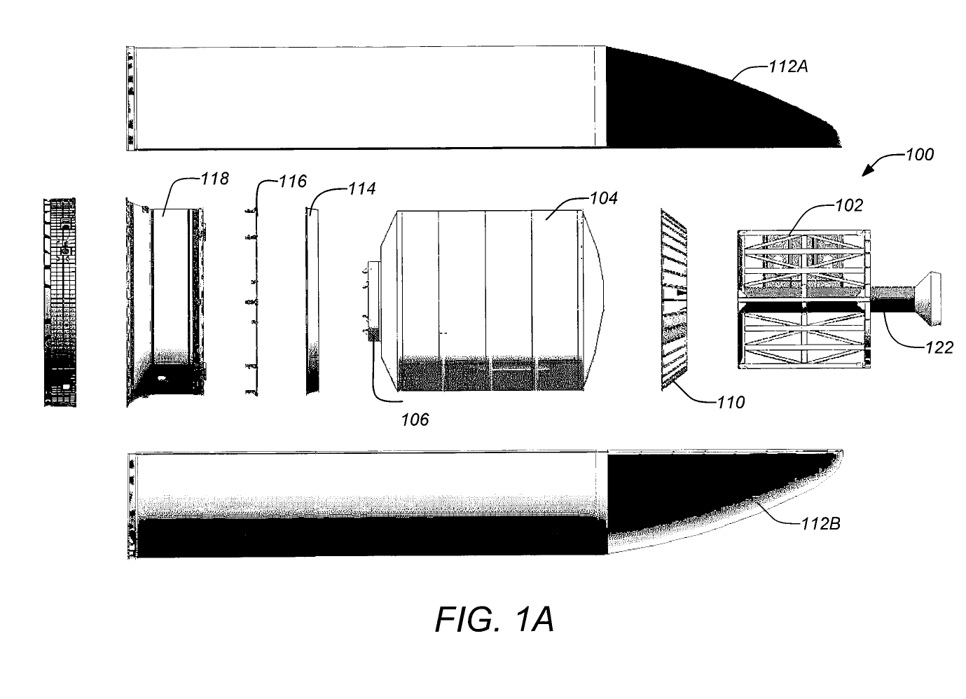

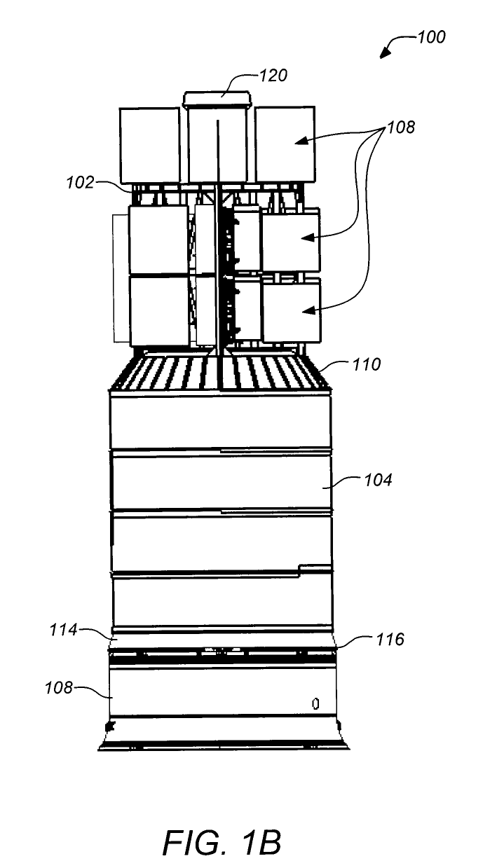

FIGS. 1A and 1B illustrate an exemplary launch vehicle cargo carrier embodiment of the invention. FIG. 1A is an exploded view and FIG. 1B is an assembled view of the primary components of the exemplary cargo carrier 100. The exemplary Delta-IV cargo carrier (D-CC) 100 can incorporate a pressurized section 104 coupled to an unpressurized carrier section 102 to accommodate all ISS Outfitting and Resupply cargo. The cargo carrier 100 is fitted within separable halves of a launch vehicle fairing 112A, 112B that will separate upon reaching orbit to allow maneuvering and manipulation of the cargo carrier 100. The unpressurized carrier section 102 provides the basis of innovation for the cargo carrier 100.

The unpressurized carrier section 102 may provide accommodations to support up to eighteen coupling devices 304, such as a standard Flight Releaseable Attach Mechanism (FRAM), which are compatible with ISS Orbital Replacement Units (ORUs) 108 as shown in FIG. 1B. The unpressurized carrier section 102 includes a first docking port 120 at its forward end, which may be compatible for docking the cargo carrier with other space vehicles such as the European ATV. A structural adapter 110 comprising a conical (or cylindrical) section can be used to attach the unpressurized carrier section 102 to the pressurized section 104 at the aft end of a rigid central structure 122.

Detailed design of the pressurized section 104 can vary as will be understood by those skilled in the art. Pre-existing designs of pressurized space capable modules may be adapted for use with the cargo carrier as the pressurized section 104. For example, the pressurized section may be adapted from the pressurized module of the European ATV. Alternately, a mission specific pressurized module may be developed as the pressurized section 104. However, a typical pressurized section 104 can provide internal volume and structural interfaces to accommodate up to twelve International Standard Payload Racks (ISPRs) or for stowing cargo within the pressurized module. The pressurized section 104 structural interfaces may be of any suitable design, such as hand operated clamping or bolting mechanisms operable by a crewmember within the pressurized environment. The pressurized section 104 may be self-contained including the necessary power and control systems to maintain a pressurized environment within a pressure secure container. The pressurized section 104 can include a second docking port 106 at its aft end that is compatible with the ISS Node 2 (i.e.; a common berthing mechanism). A second structural adapter 114 comprising a cylindrical (or conical) section may be attached to the aft end of the pressurized section 104. The second structural adapter 114, may be used to couple the cargo carrier 100 to a the launch vehicle through a clampband (e.g. released by one or more explosive bolts) 116 coupled to a third structural adapter 118 as is known in the art as a payload attach fitting.

The cargo carrier 100 may provide active thermal conditioning of the pressurized and unpressurized cargo via electrical heaters, appropriately located and powered by an external solar array, e.g. mounted on an external surface of the pressurized section 104 or as a deployable appendage (not shown) as is known in the art as a deployable solar array. The requirement of solar power or solely battery power will depend upon the particular application and mission requirements for the cargo carrier 100 as will be understood by those skilled in the art. In addition, the first 120 and second 106 docking ports may be configured to be compatible with any desired docking system as required by a particular mission.

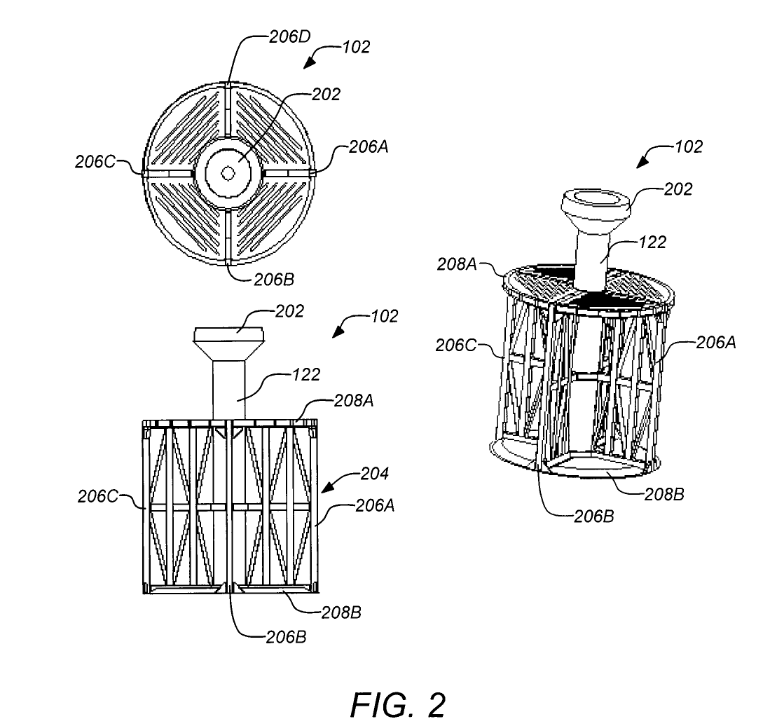

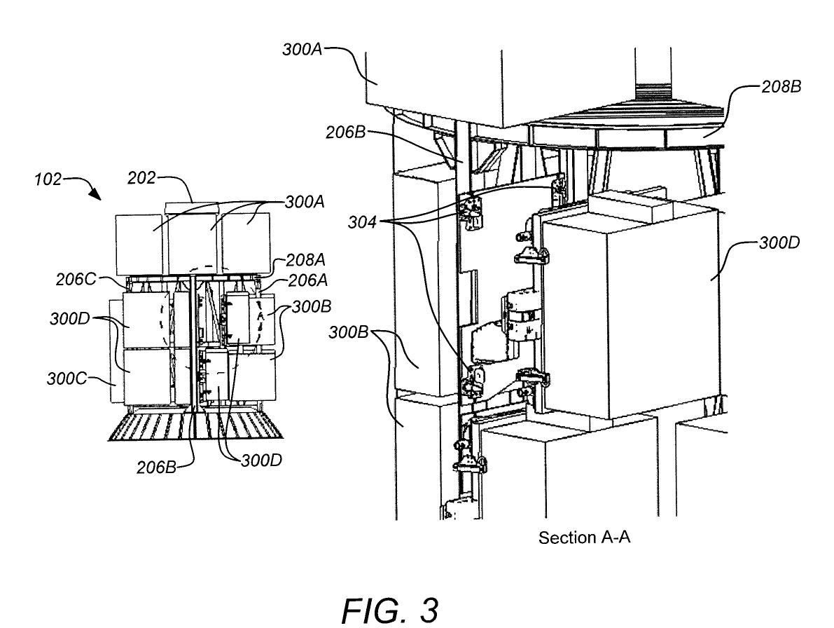

FIG. 2 illustrates top, side and isometric detailed views of an unpressurized section 102 of the exemplary launch vehicle cargo carrier 100 embodiment of the invention. The unpressurized section 102 comprises a rigid central structure 122 including a first docking port 202 at its forward end. The first docking port 202 may be designed to be compatible with the European ATV to accommodate specific exemplary applications such as resupplying the ISS. The rigid central structure 122 may comprise a hollow composite cylinder of Kevlar and/or carbon fiber construction. In addition, a frame 204 may be attached to the rigid central structure 122 to support one or more modular cargo containers, further described in FIG. 3.

The frame 204 may include four trusses 206A-206D, each coupled to extending radially from the rigid central structure 122. In addition, the frame 204 also includes an upper shelf 208A and a lower shelf 208B which are each coupled to each of the four trusses 206A-206D at the top and bottom, respectively, as well as the rigid central structure 122. The trusses 206A-206D may be constructed from lightweight aluminum beams and fittings or other suitable aerospace materials, e.g. composites and/or other strong lightweight metals. The upper and lower shelves 208A, 208B may also be constructed be strong lightweight metals and/or composites. In one example, the upper and lower shelves 208A, 208B may be constructed from ventilated aluminum honeycomb (such as HEXCEL), a known aerospace structural material. The frame 204 provides load carrying structural mounting for cargo modules, further described in FIG. 3.

FIG. 3 illustrates the unpressurized section 102 of the exemplary launch vehicle cargo carrier 100 embodiment of the invention including attached cargo modules 300. A plurality of unpressurized cargo modules 300A-300D are coupled to the four trusses 206A-206D and the upper shelf 208A. For example, the unpressurized cargo module may comprise ISS Orbital Replacement Units (ORUs). A full payload complement for the unpressurized section 102 may include four ORUs 300A of size approximately 141×120×119 inches attached to the upper shelf 208A. In addition, six ORUs 300B of size approximately 39×129×119 may be attached in pairs to three sides of the trusses 206A-206D. A single large ORU 300C of size approximately 65×240×220 inches may be attached between two opposing sides of trusses 206A, 206D. Finally, six additional ORUs 300D of size approximately 65×110×115 inches may be attached to the remaining sides of the trusses 206A-206D. All of the ORUs 300A-300D may be packaged within an envelope of an approximately 175 inch diameter.

Each of the unpressurized cargo modules 300A-300D may be attached to the frame (the trusses 206A-206D and upper shelf 208A) with coupling devices 304. For example, the coupling devices 304 may each comprise a standard Flight Releasable Attach Mechanism (FRAM). The coupling devices 304 may be used to attach each cargo module 300A-300D. The coupling devices 304 may be manually operated, e.g. by hand, or remotely operated, e.g. servo or explosive release device.

An exemplary cargo carrier embodiment of the invention as described for the Delta-IV Cargo Carrier (D-CC) provides many advantages. For example, having an ATV compatible docking port at one end, and a ISS compatible docking (berthing) port at the other, provides a unique and innovative capability. This dual-port functionality allows the cargo carrier to be captured by the ATV and transferred to the ISS by one port, and subsequently berthed to the ISS Node 2 port with the second port. The pressurized volume has a cargo capacity equivalent to the Space Shuttle, and two to three times the capacity as any competing cargo vehicle presently in development or being planned. This functionality can be enabled by marrying the cargo carrier to a Delta-IV heavy or a medium plus launch vehicle, and by offloading the transfer vehicle requirement to the existing on-orbit ATV asset, thereby maximizing the upmass capability. The unpressurized carrier section has a similar cargo carrying capability as the Space Shuttle (i.e.; up to 18 ISS ORUs). However, unlike the Space Shuttle, the cargo carrier is a highly optimized and efficient design that can increase cargo upmass efficiency and launch mass margins over competing systems.

3. Exemplary Method for Cargo Carrier Operation

Embodiments of the present invention enable a solution for providing a long-term cost-effective solution for supporting the ISS through its planned operating life extending to 2016. The Delta-IV Cargo Carrier (D-CC) is designed to provide physically and functionally similar ISS cargo interfaces as the existing Shuttle ISS cargo system. Processing of the ISS Outfitting and Resupply cargo may be performed by ground control operators. The Outfitting and Resupply cargo may be integrated to the D-CC as previously described, encapsulated in a shipping container, and transported to a Delta IV launch processing facility. The D-CC may be enclosed in a standard 5 m diameter, 62.7 ft long composite fairing, and hoisted/mated to the Delta IV launch vehicle.

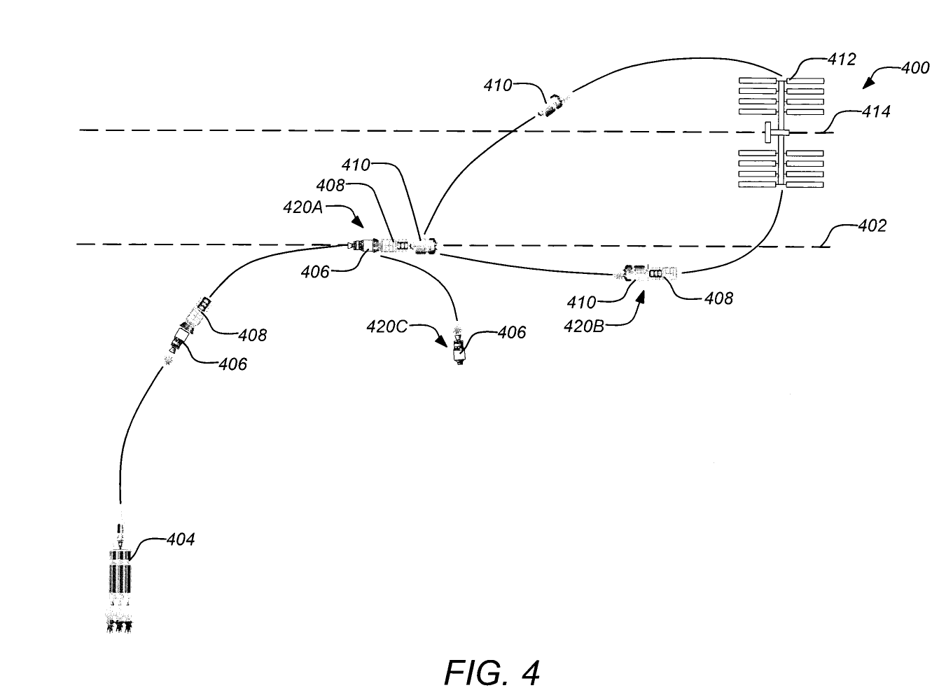

FIG. 4 illustrates an exemplary mission plan 400 for a launch vehicle cargo carrier embodiment of the invention. The exemplary Delta-IV Cargo Carrier (D-CC) mission plan 400 comprises placing International Space Station Outfitting and Resupply cargo into Low Earth Orbit (LEO) rendezvous orbit 402 utilizing a Delta IV heavy or a medium plus launch vehicle. The Delta IV launch vehicle 404 may be launched from the Earth, e.g. an Eastern range space launch complex at Cape Canaveral Air Force Station, to deliver the D-CC 408 to a circular rendezvous orbit 402 of approximately 216 nm (400 km), with an orbit inclination of approximately 51.6 degrees. The Delta-IV second stage 406 can place the D-CC 408 and its integrated ISS cargo into this stable rendezvous orbit 402 where it can be maintained by the built-in station keeping capabilities of the launch vehicle second stage 406. Once the D-CC 408 is delivered to the designated rendezvous orbit 402, an Arianespace developed Automated Transfer Vehicle (ATV) 410 or other suitable spacecraft can operate as a tug vehicle, beginning with undocking from the ISS 412.

The ATV can maneuver to the D-CC rendezvous orbit 402 and perform proximity operations in preparation for docking and capture operations. The Delta-IV second stage 406 will maintain attitude control to ensure the D-CC 408 is in proper alignment for rendezvous with the ATV 410. The ATV 410 can initiate docking and capture operations to the compatible docking interface located at the forward end of the D-CC 408. Once fully docked (as shown at rendezvous location 420A), the D-CC 408 can release the Delta-IV second stage 406 via a clampband. The ATV 410 can then maneuver the D-CC 408 back to the ISS 412 (as shown at transition location 420B), while the second stage performs safing maneuvers as shown at location 420C.

When the ATV 410 is in proximity to the ISS 412 at the mission orbit 414, the on-board crew may take over control of the ATV 410 for final proximity operations, to enable capture and berthing with the Space Station Remote Manipulator System (SSRMS). Once the D-CC 408 and ATV 410 are within reach of the Space Station Remote Manipulator System (SSRMS), the ATV 410 can shut down its propulsion system, and the SSRMS may be used to grapple one of the standard Flight Releaseable Grapple Fixtures (FRGF) that may be mounted at several locations on the D-CC 408 exterior. The SSRMS can then berth the D-CC Common Berthing Mechanism (CBM) hatch to the ISS 412, located on the aft end of the pressurized section of the D-CC 408. The D-CC 408 may be berthed at either the Node 2 Nadir docking Port, or any other suitable berthing location designated for the D-CC 408. The D-CC 408 can remain attached to the ISS 412 while the cargo is unloaded and stowed. The D-CC 408 may then be reloaded with waste materials, the hatch closed and sealed, and prepared for unberthing and deorbit by the crew.

Unberthing of the D-CC 408 may begin with the SSRMS grasping a D-CC FRGF. Thus, the SSRMS unberths the D-CC 408 from the CBM, and releases the FRGF. The ATV 410 can then perform a contamination and collision avoidance maneuver (CCAM), and backs away to a safe distance from the ISS 412. The ATV 410 can then perform stage disposal maneuvers with the D-CC 408, which is designed to assure break-up upon reentry to minimize public hazard. The design of the D-CC 408 and the defined mission plan afford many advantages.

The D-CC is designed to be compatible with ISS Assembly Outfitting and Resupply cargo. By maximizing utility of the Delta-IV second stage, the D-CC can eliminate the need for a secondary attitude control system to provide on-orbit station keeping. The D-CC can utilize existing on-orbit assets to transfer the ISS cargo from the insertion orbit to the ISS, resulting in much greater usable cargo upmass than any other conventional system. By utilizing existing on-orbit assets to transfer the D-CC from the insertion orbit to the ISS, such as the ATV, there is no need to re-launch the transfer vehicle propulsion and guidance systems each time the cargo is launched. The D-CC may be designed and optimized specifically to launch ISS cargo on a Delta-IV heavy or a medium plus launch vehicle resulting in a highly integrated and efficient space cargo delivery solution. No other conventional system utilizes the innovative dual-port approach applied in some embodiments of the present invention which provides versatile functionality. The dual-port approach also enables the innovative operational concept of utilizing the existing on-orbit ATV.

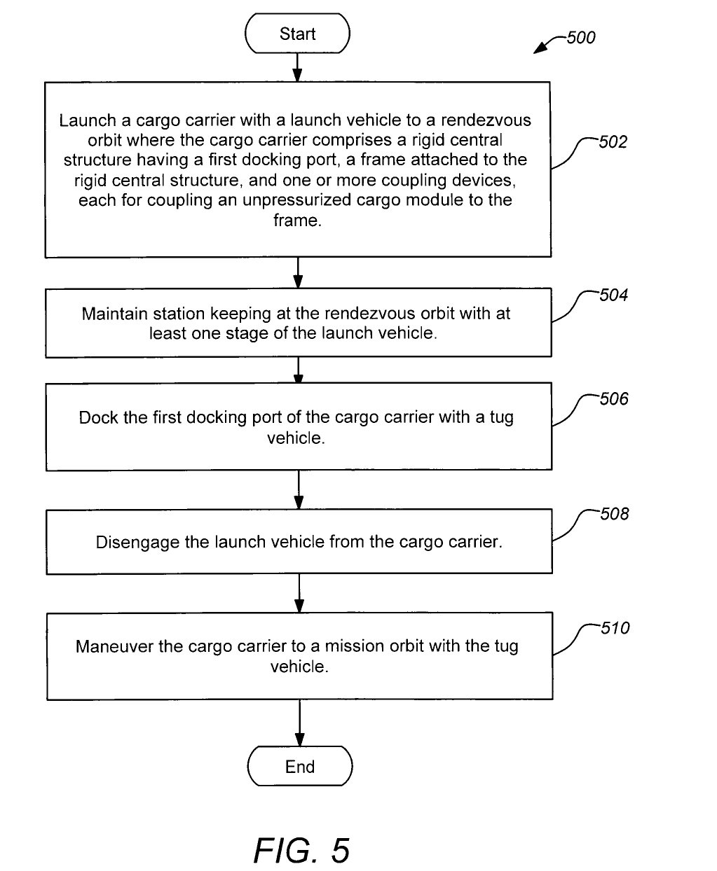

FIG. 5 is a flowchart of an exemplary method 500 for delivering cargo to space implementing an embodiment of the invention. The exemplary method 500 begins with launching a cargo carrier with a launch vehicle to a rendezvous orbit in operation 502. The cargo carrier comprises a rigid central structure having a first docking port, a frame attached to the rigid central structure, and one or more coupling devices, each for coupling an unpressurized cargo module to the frame. Next, in operation 504, station keeping is maintained at the rendezvous orbit with at least one stage of the launch vehicle. Following this, in operation 506, the first docking port is used to dock the cargo carrier with a tug vehicle. In operation 508, the launch vehicle is disengaged from the cargo carrier. Finally, in operation 510, the cargo carrier is maneuvered to a mission orbit with the tug vehicle. The method 500 may be further modified consistent with the system and apparatus embodiments previously described. For example, the cargo carrier may further comprise a pressurized cargo section attached to the rigid central structure and having a second docking port. The second docking port is used to dock with a spacecraft (e.g. the ISS) at the mission orbit. Typically, the launch vehicle comprises a disposable launch vehicle such as a Delta-IV rocket. In this case, the tug vehicle may comprise the Automated Transfer Vehicle (ATV) for the ISS.

This concludes the description including the preferred embodiments of the present invention. The foregoing description including the preferred embodiment of the invention has been presented for the purposes of illustration and description. It is not intended to be exhaustive or to limit the invention to the precise forms disclosed. Many modifications and variations are possible within the scope of the foregoing teachings. Additional variations of the present invention may be devised without departing from the inventive concept as set forth in the following claims.

What is claimed is:

1. A cargo carrier comprising:
a rigid central structure having a first docking port;
a frame attached to the rigid central structure; and
one or more coupling devices, each for coupling an unpressurized cargo module to the frame.

2. The cargo carrier of claim 1, wherein the rigid central structure comprises a hollow composite cylinder.

3. The cargo carrier of claim 1, wherein the cargo carrier comprises a payload for an expendable launch vehicle.

4. The cargo carrier of claim 1, wherein the one or more coupling devices each comprise a Flight Releasable Attach Mechanism (FRAM) and the unpressurized cargo module comprises an International Space Station Orbital Replacement Unit (ORU).

5. The cargo carrier of claim 1, wherein the first docking port is compatible with an Automated Transfer Vehicle (ATV).

6. The cargo carrier of claim 1, further comprising a pressurized cargo section attached to the rigid central structure and having a second docking port.

7. The cargo carrier of claim 6, wherein the second docking port is compatible with a second docking system of an International Space Station Common Berthing Mechanism.

8. The cargo carrier of claim 6, wherein the pressurized cargo section comprises one or more structural interfaces each for an International Standard Payload Rack (ISPR).

9. The cargo carrier of claim 1, wherein the frame comprises four trusses, each coupled to the rigid central structure and extending radially therefrom, and an upper shelf and a lower shelf, coupled to each of the four trusses and the rigid central structure.

10. The cargo carrier of claim 9, wherein a plurality of unpressurized cargo modules are coupled to the four trusses and the upper shelf.

11. A method for delivering cargo to space comprising the steps of:
launching a cargo carrier with a launch vehicle to a rendezvous orbit, where the cargo carrier comprises a rigid central structure having a first docking port, a frame attached to the rigid central structure, and one or more coupling devices, each for coupling an unpressurized cargo module to the frame;
maintaining station keeping at the rendezvous orbit with at least one stage of the launch vehicle;
docking the first docking port of the cargo carrier with a tug vehicle;
disengaging the launch vehicle from the cargo carrier; and
maneuvering the cargo carrier to a mission orbit with the tug vehicle.

12. The method of claim 11, wherein the rigid central structure comprises a hollow composite cylinder.

13. The method of claim 11, wherein the launch vehicle comprises an expendable launch vehicle.

14. The method of claim 11, wherein the one or more coupling devices each comprise a Flight Releasable Attach Mechanism (FRAM) and the unpressurized cargo module comprises an International Space Station Orbital Replacement Unit (ORU).

15. The method of claim 11, wherein the tug vehicle comprises an Automated Transfer Vehicle (ATV).

16. The method of claim 11, wherein the cargo carrier further comprises a pressurized cargo section attached to the rigid central structure and having a second docking port.

17. The method of claim 16, wherein the second docking port is docked with a second docking system of an International Space Station Common Berthing Mechanism at the mission orbit.

18. The method of claim 16, wherein the pressurized cargo section comprises one or more structural interfaces each for an International Standard Payload Rack (ISPR).

19. The method of claim 11, wherein the frame comprises four trusses, each coupled to the rigid central structure and extending radially therefrom, and an upper shelf and a lower shelf, coupled to each of the four trusses and the rigid central structure.

20. The method of claim 19, wherein a plurality of unpressurized cargo modules are coupled to the four trusses and the upper shelf.
